(19) United States
(12) Patent Application Publication
(10) Pub. No.: US 2023/0056472 A1
(43) Pub. Date: Feb. 23, 2023

(54) FIRING CUTOUT RAPID GENERATION AIDED BY MACHINE LEARNING

(71) Applicant: Raytheon Company, Waltham, MA (US)

(72) Inventors: Julie A. Graham, Tucson, AZ (US); Brian A. Gin, Vail, AZ (US); Emile M. Szlemko, Vail, AZ (US)

(21) Appl. No.: 17/406,754

(22) Filed: Aug. 19, 2021

(51) Int. Cl. F41G 7/00; F41G 7/34; G06T 7/70

(52) U.S. Cl. CPC F41G 7/007; F41G 7/343; G06T 7/70; G06T 2207/10048; G06T 2207/30212

(57) ABSTRACT

A system includes and maintains a machine learning algorithm. The machine learning algorithm is trained to identify non-targets in an environment. The system receives an image of the environment, and identifies the non-targets in the image using the trained machine learning algorithm. The system then generates a firing cut out map for overlaying on the image of the environment based on the identified non-targets in the image of the environment.

### TECHNICAL FIELD

Embodiments described herein generally relate to the generation of firing cut out maps in a missile launching system, and in an embodiment, but not by way of limitation, firing cutout rapid generation aided by machine learning.

### BACKGROUND

Generation of firing cutout maps for missile launching systems that fire at low elevations usually involves time consuming surveying of surrounding areas. Shore and land-based environments change rapidly, and there is normally not enough time to re-survey the area. Additionally, launching systems are often not located close enough to the system sensors to develop firing cutout maps that reflect the exact relationship of close-in objects to the launching system. Also, current systems in general do not support fire on the run capabilities. Firing cut-out maps need to be produced rapidly and safely to reflect the changing scene that launching systems face.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating operations and features of a firing cut out method and system for the generation of a firing cut out map.

FIGS. 2A, 2B, and 2C illustrate an example of a firing cut out map.

FIG. 3 illustrates an embodiment of a computer architecture upon which one or more embodiments of the present disclosure can execute.

### DETAILED DESCRIPTION

An embodiment is a method for using machine learning to aid an operator in quickly constructing a firing cutout map that meets safety requirements. While current efforts with machine learning are used to identify targets (e.g., Automatic Target Recognition (ATR)), the current embodiment identifies all structures and objects that should not be targeted.

An embodiment uses a standalone piece of equipment (which can be referred to as the scene machine (SM)) that is co-located with a missile launching system. The embodiment includes two or more image sensing devices such as two high quality mid-wave infra-red (IR) cameras, a touchscreen operator interface, a processor housing the necessary algorithms, and multi-media writing capability. When the scene machine is first deployed in a unique operating environment, for example the Persian Gulf off-shore oil fields, an image collection campaign is conducted to “teach” the scene machine's image classification software which types of objects are to be protected (i.e., included in a no-fire zone). For example, in the oil field environment, the scene machine would be taught that oil platforms, venting stacks, and large docked ships are objects to be included in the no fire zone. After the learning is completed, the image classification software is loaded in each scene machine that is associated with the launching system.

An operator then initializes a scan of the scene in front of the launching system using the IR cameras. The scene machine uses the machine-learned image classification to identify and display all the objects it considers to be non-targets. Having two or more IR cameras or other image sensing devices permits the scene machine to provide range estimates. Using the range estimates, an observed object is not included in the map if it is beyond the range where it is in danger of missile contact. Using the touchscreen, the operator can deselect any object that the operator does not want to include in the cut-out map.

The use of machine learning increases the safety of firing cut out map generation as the operator alone may miss an object by human error or failure to recognize it. However, allowing the operator to de-select an object keeps all possible objects to be protected in the map unless the operator makes a conscious decision to remove it.

The scene machine then generates a firing cut out map that meets all the requirements of the launching system. Such requirements could be additional space around the object for safety margins or system specific rules (e.g., the random access memory (RAM) of the launching system requires minimum zone widths, and dimensions must be quantized).

Once the firing cut out map is finalized, it can either be sent directly to the launching system via an Ethernet connection or written to whatever media the launching system uses (for example, a RAM of the launching system can store maps in an EEPROM that resides on a main processor board and is removable for re-programming).

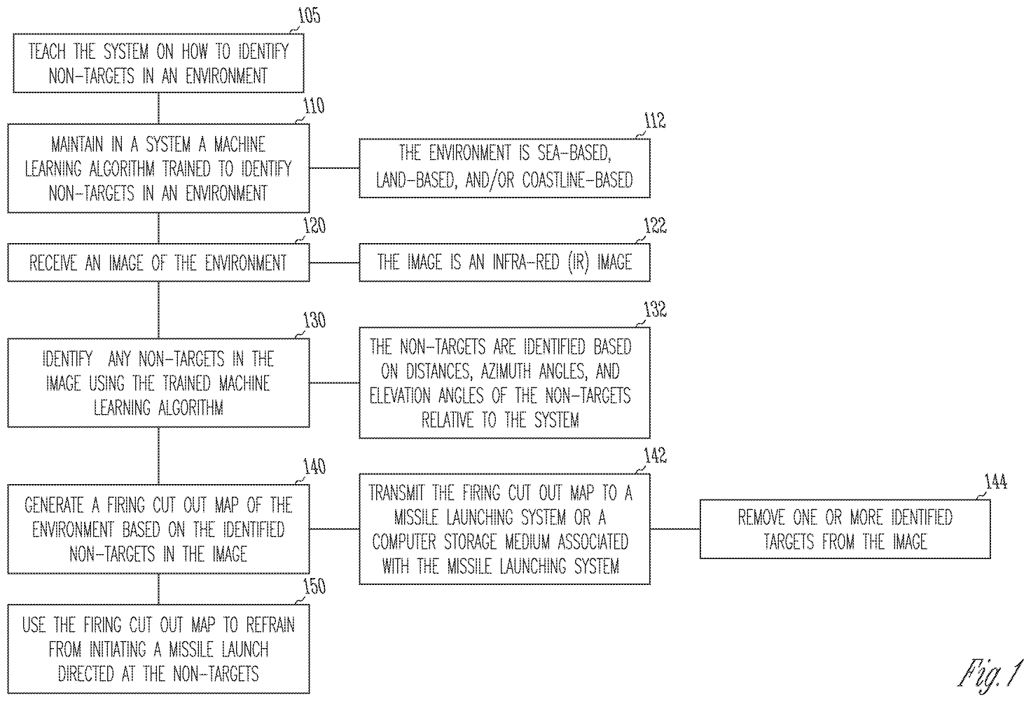

The above-described process of generating firing cut out maps is illustrated in graphic form in FIG. 1. FIG. 1 is a block diagram illustrating operations and features of systems and methods to generate firing cut out maps. FIG. 1 includes a number of feature and operation blocks 110-150. Though arranged substantially serially in the example of FIG. 1, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIG. 1, at 105, a machine learning algorithm is trained how to identify non-targets in an environment, and then at 110, the machine learning algorithm that is trained to identify one or more non-targets in an environment is maintained in a computer processor and/or a computer memory. As noted above, this machine learning algorithm and computer system can be referred to as the scene machine. The system is first deployed in the environment, and an image collection campaign is conducted to teach the system the objects that are to be avoided, that is, the non-targets. After the training, the system is placed next to one or more launching systems, and when put into use, an operator initiates a scan of the firing area of the launching system. The environment can be sea-based, land-based, or coastline-based (112).

At 120, the system receives from the scan an image of the environment. In an embodiment, the image is an infra-red (IR) image (122). At 130, the system identifies any non-targets in the image using the trained machine learning algorithm. As indicated at 132, these non-targets were identified based on distances, azimuth angles, and elevation angles of the non-targets relative to the system.

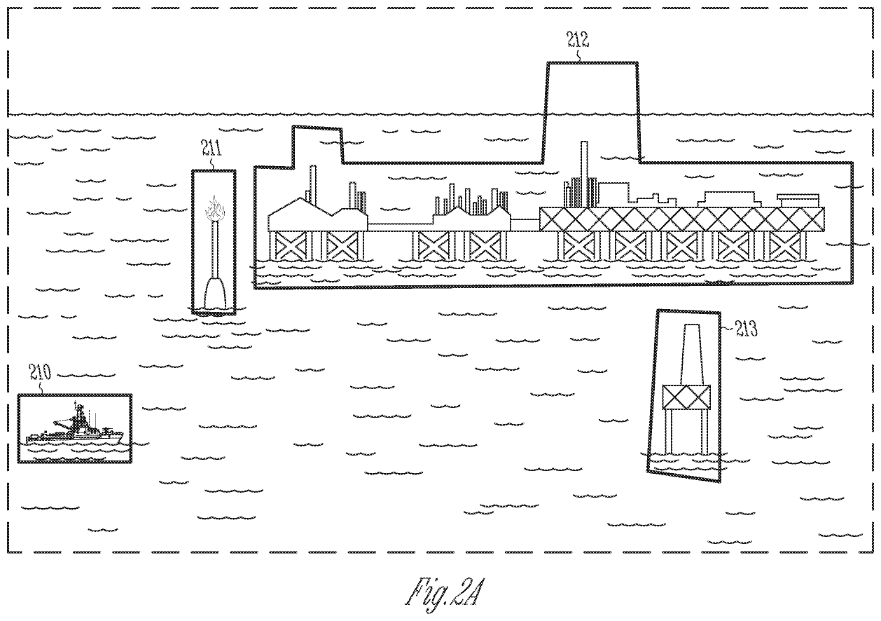

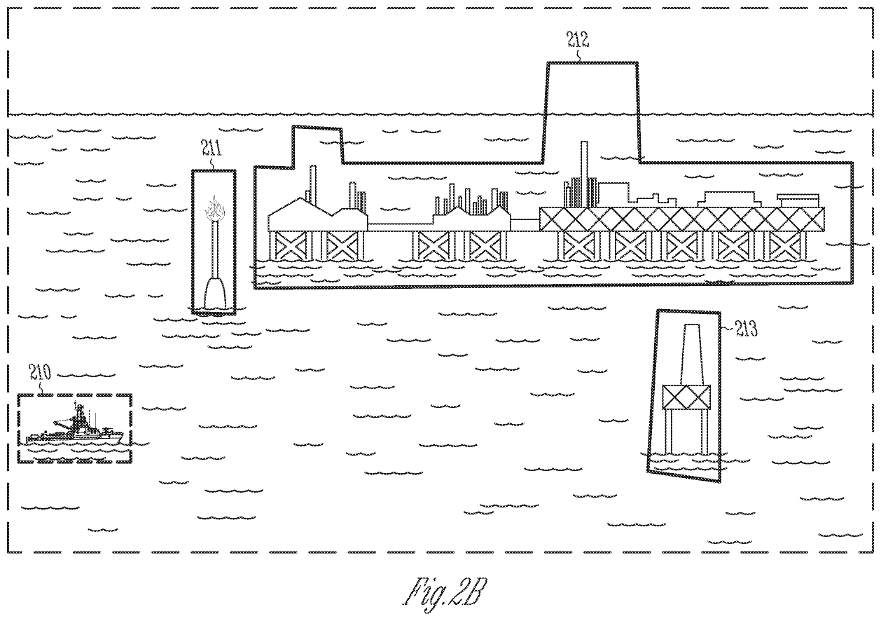

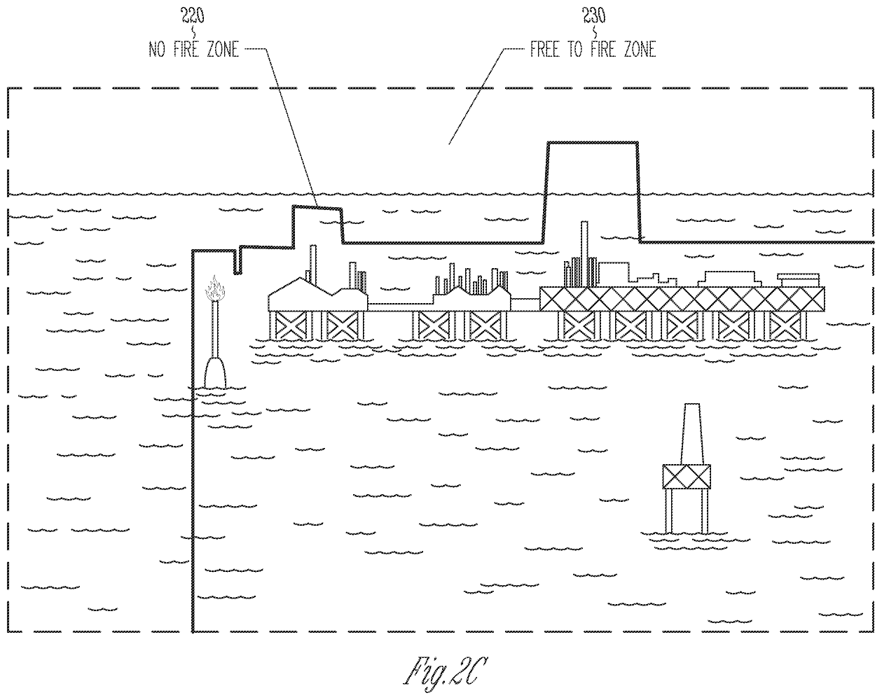

At 140, the system generates a firing cut out map for overlaying on the image of the environment based on the identified non-targets in the image of the environment. At 142, the firing cut out map is transmitted to a missile launching system or a computer storage medium associated with the missile launching system. An example of such a firing cut out map is illustrated in FIG. 2A. The identified non-targets in FIG. 2A are indicated by boxes 210, 211, 212, and 213. At 144, one or more identified targets can be removed from the image. This is illustrated in FIG. 2A, wherein an operator has chosen to remove the small watercraft in the scene, which is identified by 210, because the operator deems the small watercraft to be temporary. In an embodiment, this removal by the operator can be done via a touchscreen. The final firing cut out map is illustrated in FIG. 2C, which indicates the no fire zone 220 and the fire zone 230. FIG. 2C further illustrates that the small watercraft 210 has been removed from the firing cut out map by the operator.

At 150, the system uses the firing cut out map to refrain from initiating a missile launch directed at the non-targets. In a missile launch system, there are many sub-systems that contribute to fire and/or no-fire decisions, and the firing cut out map is just one of those sub-systems.

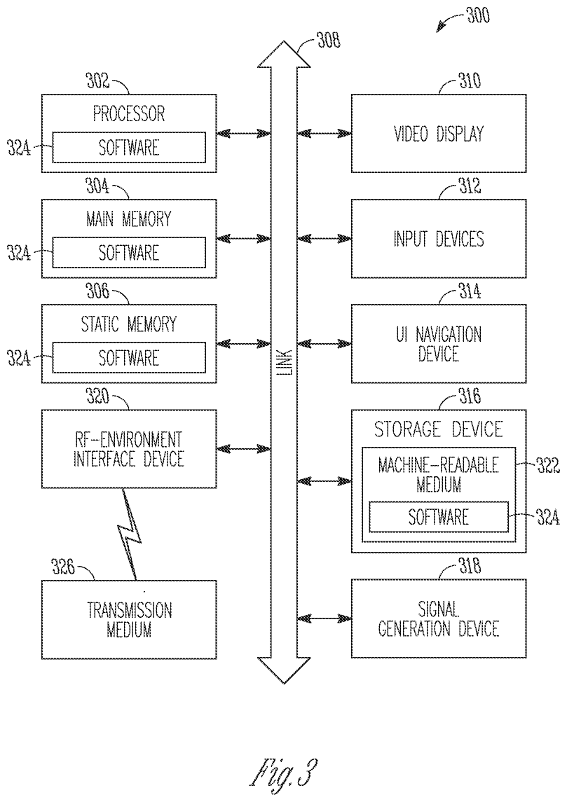

FIG. 3 is a block diagram illustrating a computing and communications platform 300 in the example form of a general-purpose machine on which some or all the operations of FIG. 1 may be carried out according to various embodiments. In certain embodiments, programming of the computing platform 300 according to one or more particular algorithms produces a special-purpose machine upon execution of that programming. In a networked deployment, the computing platform 300 may operate in the capacity of either a server or a client machine in server-client network environments, or it may act as a peer machine in peer-to-peer (or distributed) network environments.

Example computing platform 300 includes at least one processor 302 (e.g., a central processing unit (CPU), a graphics processing unit (GPU) or both, processor cores, compute nodes, etc.), a main memory 304 and a static memory 306, which communicate with each other via a link 308 (e.g., bus). The computing platform 300 may further include a video display unit 310, input devices 312 (e.g., a keyboard, camera, microphone), and a user interface (UI) navigation device 314 (e.g., mouse, touchscreen). The computing platform 300 may additionally include a storage device 316 (e.g., a drive unit), a signal generation device 318 (e.g., a speaker), and a RF-environment interface device (RFEID) 320.

The storage device 316 includes a non-transitory machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computing platform 300, with the main memory 304, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

RFEID 320 includes radio receiver circuitry, along with analog-to-digital conversion circuitry, and interface circuitry to communicate via link 308 according to various embodiments. Various form factors are contemplated for RFEID 320. For instance, RFEID may be in the form of a wideband radio receiver, or scanning radio receiver, that interfaces with processor 302 via link 308. In one example, link 308 includes a PCI Express (PCIe) bus, including a slot into which the NIC form-factor may removably engage. In another embodiment, RFEID 320 includes circuitry laid out on a motherboard together with local link circuitry, processor interface circuitry, other input/output circuitry, memory circuitry, storage device and peripheral controller circuitry, and the like. In another embodiment, RFEID 320 is a peripheral that interfaces with link 308 via a peripheral input/output port such as a universal serial bus (USB) port. RFEID 320 receives RF emissions over wireless transmission medium 326. RFEID 320 may be constructed to receive RADAR signaling, radio communications signaling, unintentional emissions, or some combination of such emissions.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A process comprising:
maintaining in a computer processor a machine learning algorithm, the machine learning algorithm trained to identify one or more non-targets in an environment;
receiving into the computer processor an image of the environment;
identifying the one or more non-targets in the image of the environment using the trained machine learning algorithm; and
generating a firing cut out map for overlaying on the image of the environment based on the identified one or more non-targets in the image of the environment.

2. The process of claim 1, wherein the image comprises an infra-red (IR) image.

3. The process of claim 1, comprising identifying the one or more non-targets based on distances, azimuth angles, and elevation angles of the one or more non-targets relative to the computer processor.

4. The process of claim 1, comprising removing one or more of the identified non-targets from the image prior to generating the firing cut out map.

5. The process of claim 1, comprising using the firing cut out map to refrain from initiating a missile launch directed at the one or more non-targets.

6. The process of claim 1, comprising transmitting the firing cut out map to a missile launching system or a computer storage medium associated with the missile launching system.

7. The process of claim 1, wherein the environment comprises one or more of a sea-based, a land-based, or a coastline-based environment.

8. A system comprising:
a computer processor;
a computer memory coupled to the computer processor;
two or more image sensing devices coupled to the computer processor; and
a touch screen operator interface;
wherein the computer processor is operable for:
maintaining in a computer processor a machine learning algorithm, the machine learning algorithm trained to identify one or more non-targets in an environment;
receiving into the computer processor an image of the environment;
identifying the one or more non-targets in the image of the environment using the trained machine learning algorithm; and
generating a firing cut out map for overlaying on the image of the environment based on the identified one or more non-targets in the image of the environment.

9. The system of claim 8, wherein the two or more image sensing devices comprise mid-wave infrared (IR) sensing devices.

10. The system of claim 8, comprising identifying the one or more non-targets based on distances, azimuth angles, and elevation angles of the one or more non-targets relative to the computer processor.

11. The system of claim 8, comprising removing one or more of the identified non-targets from the image prior to generating the firing cut out map.

12. The system of claim 8, comprising using the firing cut out map to refrain from initiating a missile launch directed at the one or more non-targets.

13. The system of claim 8, comprising transmitting the firing cut out map to a missile launching system or a computer storage medium associated with the missile launching system.

14. The system of claim 8, wherein the environment comprises one or more of a sea-based, a land-based, or a coastline-based environment.

15. A non-transitory machine-readable medium comprising instructions that when executed by a computer processor execute a process comprising:
maintaining in the computer processor a machine learning algorithm, the machine learning algorithm trained to identify one or more non-targets in an environment;
receiving into the computer processor an image of the environment;
identifying the one or more non-targets in the image of the environment using the trained machine learning algorithm; and
generating a firing cut out map for overlaying on the image of the environment based on the identified one or more non-targets in the image of the environment.

16. The non-transitory machine-readable medium of claim 15, wherein the image comprises an infra-red (IR) image.

17. The non-transitory machine-readable medium of claim 15, comprising instructions for identifying the one or more non-targets based on distances, azimuth angles, and elevation angles of the one or more non-targets relative to the computer processor.

18. The non-transitory machine-readable medium of claim 15, comprising instructions for removing one or more of the identified non-targets from the image prior to generating the firing cut out map.

19. The non-transitory machine-readable medium of claim 15, comprising instructions for using the firing cut out map to refrain from initiating a missile launch directed at the one or more non-targets.

20. The non-transitory machine-readable medium of claim 15, comprising instructions for transmitting the firing cut out map to a missile launching system or a computer storage medium associated with the missile launching system.
